(19) United States
(12) Patent Application Publication
(10) Pub. No.: US 2023/0212868 A1
(43) Pub. Date: Jul. 6, 2023

(54) CLEANING METHOD FOR WATER SURFACE OF SWIMMING POOLS AND CLEANING ROBOT

(71) Applicant: Shenzhen Seauto Technology Co.,Ltd., Shenzhen (CN)

(72) Inventor: ZHUOMING DENG, Shenzhen (CN)

(21) Appl. No.: 17/585,888

(22) Filed: Jan. 27, 2022

(30) Foreign Application Priority Data
Jan. 5, 2022 (CN) 202210024191.X

(51) Int. Cl. E04H 4/16; A47L 9/28; A47L 9/00; A47L 7/00; G05D 1/02

(52) U.S. Cl. CPC E04H 4/1654; A47L 9/2805; A47L 9/009; A47L 7/0009; A47L 9/2852; G05D 1/0206; A47L 2201/04; G05D 2201/0203

(57) ABSTRACT

The present disclosure provides a cleaning method for the water surface of swimming pools and cleaning robot, the cleaning robot comprising a cleaning robot body, a sonar arranged around the cleaning robot body, two rear thrusters located at the tail of cleaning robot body. According to the present disclosure, as long as the cleaning robot body is placed on the water surface of the pool, cleaning robot body floating on the surface of the pool may automatically move and steer, so as to ensure that it can turn in advance before encountering the pool wall and won't knock against the pool wall, reduce the probability of malfunction and damaging of cleaning robot body, and the cleaning robot body can cover the entire water surface of pool and the pool wall, there is no omitting of cleaned water surface, and there is no need for excessive human involvement, it makes it easy for cleaning staffs to clean, when the cleaning robot body cleans the water surface of the pool, the cleaning staffs can carry out other cleaning work, which improved the cleaning efficiency of the cleaning staffs.

### RELATED APPLICATIONS

This application claims the benefit of priority to Chinese Patent Application Number 202210024191.X filed on Jan. 5, 2022, in China National Intellectual Property Administration, the contents of which are hereby incorporated by reference.

### TECHNICAL FIELD

The present disclosure relates to the art of cleaning water surface of swimming pool, and in particular relates to a cleaning method for water surface of swimming pools and cleaning robot.

### BACKGROUND ART

With the rise of sport for general population, more and more people choose swimming as a form of exercise that can both increase the joy of life and strengthen the body. In a crowded public pool, the water quality of the swimming pool requires constant monitoring. For example, if a large amounts of suspended solids and impurities, such as hair in the swimming pool, were not cleaned up in time, bacterial will be easy to breed, and transmit infectious diseases. However, complete replacement of pool water will cause a lot of water waste.

Currently, hand-held salvage nets with long-pole are used for suspending solids salvage in most swimming pools, but the length of the hand of the hand-held salvage nets with long-pole is difficult to reach the depth of the pool, resulting in a limited cleaning range and poor cleaning effect. Therefore, using hand-held salvage nets with long-pole to clean up impurities adhered to the wall of pools may result in incomplete cleaning.

Another method of cleaning up the entire water surface of the pools is to use a remote-controlled robot. Both the above cleaning methods require human involvement which may be inconvenient.

The present disclosure provides am improved method of cleaning water surface of swimming pools and a cleaning robot.

### SUMMARY OF DISCLOSURE

The present disclosure provides a cleaning method for water surface of swimming pools and cleaning robot to solve the disadvantages existing in the prior art.

In order to achieve the above object, the present disclosure adopts the following technical solutions: a cleaning method for the water surface of swimming pools according to the present embodiment, comprising a cleaning robot body, a sonar located around the cleaning robot body, rear thrusters located at the tail of the cleaning robot body, an angle sensor located in the cleaning robot body, a controller and a side thruster located on a side of the cleaning robot body, wherein the cleaning method comprising:

S1, putting the cleaning robot body into the pool in any direction;

S2, the cleaning robot body calculates an angle between a travel direction and a pool wall of the pool;

S3, when the cleaning robot body is in contact with the pool wall, and the cleaning robot moving close to the pool wall, steering in advance after a head of the cleaning robot body being at a certain distance from the pool wall, and moving close to the pool wall again;

S4, the cleaning robot body is moved to a first contact position with the pool wall, and then the cleaning robot body is moved forward in a direction perpendicular to a pool wall in front of thereof;

S5, when the cleaning robot body is a certain distance from the front pool wall, turn around in advance and moves forward in the opposite direction of the previous travel direction.

Preferably, calculation in S2 comprising:

the sonar on a head emits multiple ultrasonic beams after falling into the water, wherein the ultrasonic beams perpendicular to the cleaning robot body is X1, when the X1 is not the shortest of all the ultrasonic beams, the ultrasonic beams perpendicular to the pool wall is X2, the length of the X2 is the shortest, an angle between a side of the X1 near the X2 and the pool wall is a, and the calculation method of ∠α is: ∠α=arcsin (X2/X1).

Preferably, the details of the S2-S3 comprising:

When the X1 and the pool wall are tilted, turn a side of the cleaning robot body away from the side thruster through the revolving speed difference between the two rear thrusters, the cleaning robot body is steered toward the side of away from the side thruster, through the rotation of the cleaning robot body controlled by the angle sensor in cooperation with the controller, the rotational amplitude and ∠α degrees are equal, when the side thruster is closed to the pool wall, the steering angle of the cleaning robot body 1 is ∠α+90°; when X1 is perpendicular to the pool wall, the cleaning robot body turns vertically toward a side away from the side thruster, and when the side of the cleaning robot body away from the side propeller is parallel to the pool wall, start the side thruster, the side thruster pushes the cleaning robot body into contact with the pool wall, then after the two rear thrusters at the same speed push the cleaning robot body at a constant speed along the pool wall, when cleaning robot body encounters the pool wall in the forward direction, and the cleaning robot body is X3 away from the pool wall in front of thereof, the cleaning robot body is controlled to previously steer vertically toward the side of X2 near the side thruster by the angle sensor in cooperation with the controller.

Preferably, the details of the S4-S5 comprising:

The cleaning robot body is moved to the first contact position with the pool wall, and then the cleaning robot body is moved along the vertical direction with the pool wall in front of thereof, when the cleaning robot body is X4 away from the pool wall in front of thereof, the cleaning robot body is controlled to turning around toward the side of sweeping area near the pool wall by the angle sensor in cooperation with the controller, and then cleaning robot body is previously moved in the opposite direction of the direction before turning around, the next time encountering the pool wall, the cleaning robot body is controlled to previously turn around toward the opposite direction by the angle sensor in cooperation with the controller, there is a local intersection between two travel routes of cleaning robot body, wherein an intersection area is P, and then repeat the steps of S4-S5, the water surface of the entire pool could be cleaned up.

Preferably, X3 is equal to turning radius of cleaning robot body.

Preferably, X4 is equal to turning radius of cleaning robot body.

Preferably, the intersection area P is 0.1 times the sum of two cleaning area by the cleaning robot body.

A cleaning robot for the water surface of pools applied to the described cleaning method for the water surface of pools, wherein cleaning robot body is fixed with a battery, wherein the angle sensor, the sonar, the two rear thrusters, the side thruster and the battery are electrically connected to the controller.

Preferably, guide wheels are rotatably mounted at a plurality of corners of the cleaning robot body.

### Feature Effects of Disclosure

Compared with the prior art, the advantageous effects of the present disclosure are:

According to the present disclosure, as long as the cleaning robot body is placed on the water surface of the pool, cleaning robot body floating on the surface of the pool may automatically move and steer, so as to ensure that it can turn in advance before encountering the pool wall and will not knock against the pool wall, reduce the probability of malfunction and damaging of cleaning robot body, and the cleaning robot body can cover the entire water surface of pool and the pool wall, there is no omitting of cleaned water surface, and there is no need for excessive human involvement, which makes it easier for cleaning staffs to clean, when the cleaning robot body cleans the water surface of the pool, the cleaning staffs can carry out other cleaning work, which improved the cleaning efficiency of the cleaning staffs.

### BRIEF DESCRIPTION OF DRAWINGS

FIG. 1 is a schematic flow diagram of a cleaning method of the water surface of pools according to the present disclosure.

FIG. 2 is an internal circuit diagram of a cleaning robot for the water surface of pools according to the present disclosure.

FIG. 3 is a schematic diagram of advancing of a cleaning robot for the water surface of pools and cleaning the swimming pool wall simultaneously, according to the present disclosure.

FIG. 4 is a schematic diagram of the enlarged structure of Part A in FIG. 3.

FIG. 5 is a schematic diagram of advancing of a cleaning robot for the water surface of pools while cleaning the water surface of swimming pool according to the present disclosure.

FIG. 6 is a schematic diagram of an overall structure of a cleaning robot for the water surface of pools according to the present disclosure.

FIG. 7 is a schematic diagram of an overall structure of a cleaning robot for the water surface of pools according to the present disclosure.

FIG. 8 is a schematic diagram of an internal structure of a cleaning robot for the water surface of pools according to the present disclosure.

### DESCRIPTION OF EMBODIMENTS

Hereinafter, the technical solutions in the embodiments of the present disclosure will be described clearly and completely with reference to the drawings of the embodiments of the present disclosure. Obviously, the embodiments described are only partial embodiments of the present disclosure, rather than all of the embodiments. Based on the embodiments of the present disclosure, all other embodiments obtained by those skilled in the art without creative efforts all belong to the scope of protection of the present disclosure.

### Embodiments

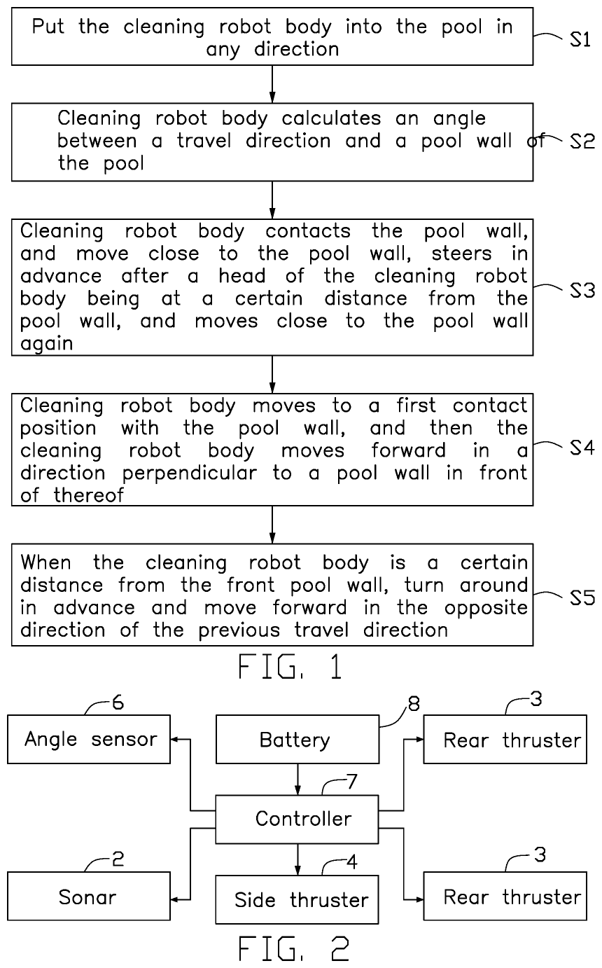

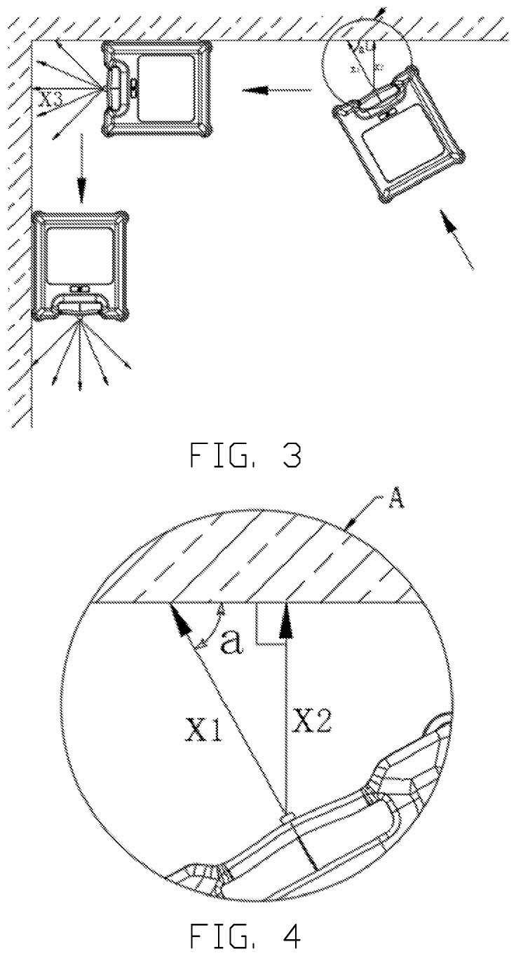

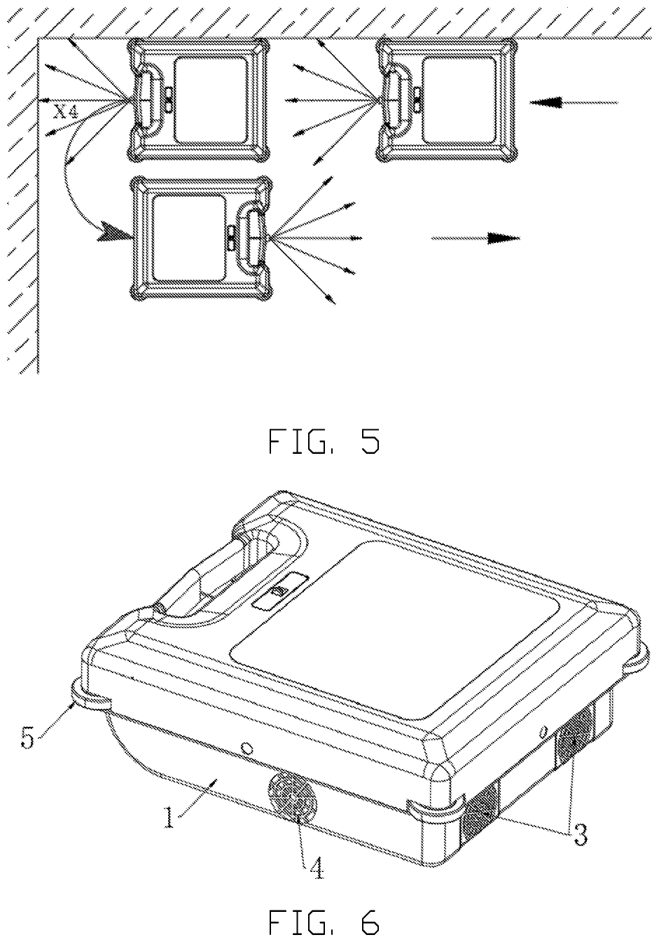

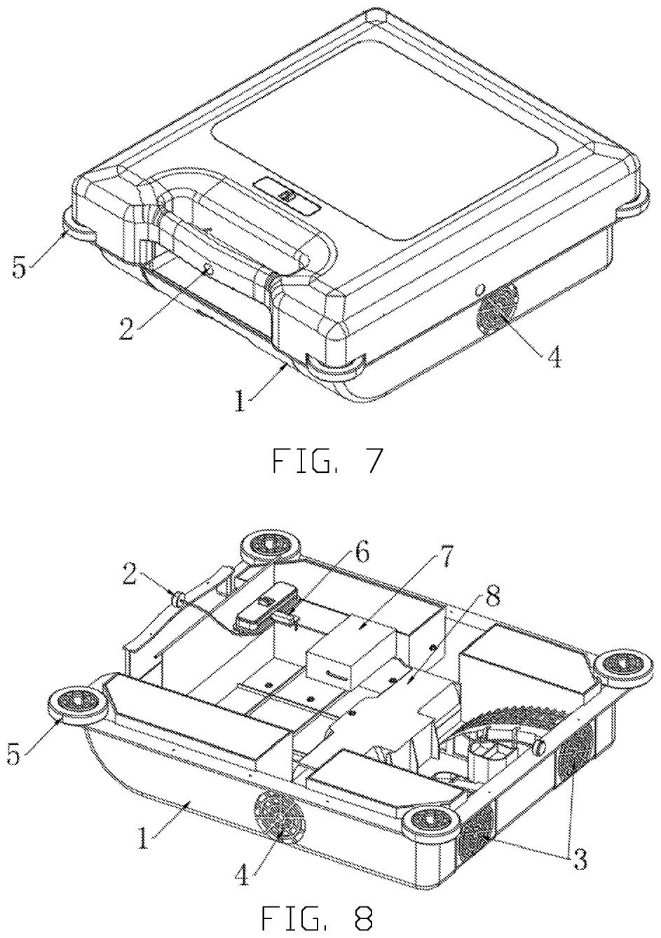

Referring to FIGS. 1-8, a cleaning method for water surface of swimming pools employing a cleaning robot according to the present embodiment, the cleaning robot comprising a cleaning robot body 1, a sonar 2 located around the cleaning robot body 1, rear thrusters located at the tail of the cleaning robot body 1, an angle sensor 6 located in the cleaning robot body 1, a controller 7 and a side thruster located on a side of the cleaning robot body 1, wherein the cleaning method comprising:

S1, putting the cleaning robot body 1 into the pool in any direction;

S2, the cleaning robot body 1 calculates an angle between a travel direction and a pool wall of the pool;

S3, the cleaning robot body 1 contacts the pool wall, and move close to the pool wall, steers in advance after a head of the cleaning robot body 1 being at a certain distance from the pool wall, and moved close to the pool wall again;

S4, the cleaning robot body 1 is moved to a first contact position with the pool wall, and then the cleaning robot body 1 is moved forward in a direction perpendicular to a pool wall in front of thereof;

S5, when the cleaning robot body 1 is a certain distance from the front pool wall, it turns around in advance and moves forward in the opposite direction of the previous travel direction.

The calculation in S2 is shown as follows:

The sonar 2 on a head emits multiple ultrasonic beams after falling into the water, wherein the ultrasonic beams perpendicular to the cleaning robot body 1 is X1, when the X1 is not the shortest of all the ultrasonic beams, the ultrasonic beams perpendicular to the pool wall is X2, the length of the X2 is the shortest, an angle between a side of the X1 near the X2 and the pool wall is a, and the calculation method of ∠α is: ∠α=arcsin X2/X1.

When the X1 and the pool wall are tilted, turn a side of the cleaning robot body 1 away from the side thruster 4 through the revolving speed difference between the two rear thrusters 3, the cleaning robot body 1 may be steered toward the side of away from the side thruster 4, through the rotation of the cleaning robot body 1 controlled by the angle sensor 6 in cooperation with the controller 7, the rotational amplitude and La degrees may be equal, when the side thruster 4 is closed to the pool wall, the steering angle of the cleaning robot body 1 may be ∠α+90°;

when X1 is perpendicular to the pool wall, the cleaning robot body 1 turns vertically toward a side away from the side thruster 4, and
when the side of the cleaning robot body 1 away from the side thruster 4 is parallel to the pool wall, start the side thruster 4, the side thruster 4 pushes the cleaning robot body 1 into contact with the pool wall, then after the two rear thrusters 3 at the same speed push the cleaning robot body 1 at a constant speed along the pool wall, when cleaning robot body 1 encounters the pool wall in the forward direction, and the cleaning robot body 1 is X3 away from the pool wall of thereof, the cleaning robot body 1 is controlled to previously steer vertically toward the side of X2 near the side thruster 4 by the angle sensor 6 in cooperation with the controller 7.

When the cleaning robot body 1 encounters the pool wall in the forward direction, and the cleaning robot body 1 is X3 [X3=turning radius of cleaning robot body 1]away from the pool wall in front, the cleaning robot body 1 may be controlled to previously steer toward the side of X2 near X1 by the angle sensor 6 in cooperation with the controller 7, the steering angle is equal to degrees of ∠α.

The details of the S4-S5 comprising:

Cleaning robot body 1 may move to a first contact position with the pool wall, and then the cleaning robot body 1 may move along the vertical direction with the pool wall in front of thereof, when the cleaning robot body 1 is X4 away from the pool wall in front of thereof, the cleaning robot body 1 may be controlled to turn around toward the side of sweeping area near the pool wall by the angle sensor 6 in cooperation with the controller 7, and then cleaning robot body 1 may previously move in the opposite direction of the direction before turning around, the next time encountering the pool wall, the cleaning robot body 1 may be controlled to previously turn around toward the opposite direction by the angle sensor 6 in cooperation with the controller 7, there is a local intersection between two travel routes of cleaning robot body 1, wherein an intersection area is P, and then repeat the steps of S4-S5, the water surface of the entire pool may be cleaned up.

Further, when there is a speed difference between the two rear thrusters 3, the cleaning robot body 1 turns to the side of the slower rear thrusters 3, and when the two rear thrusters 3 advance in opposite directions, the cleaning robot body 1 turns to the side of the rear thruster 3 that pushed the cleaning robot body 1 backwards.

X3 is equal to the turning radius of cleaning robot body 1.

X4 is equal to the turning radius of cleaning robot body 1.

Further, since X3 and X4 are both equal to the turning radius of cleaning robot body 1, the direct contact between cleaning robot body 1 and the pool wall during steering may be avoided, reducing the damage of cleaning robot body 1 by knocking, while the cleaning robot body 1 can steer against the pool wall, there will be no cleaning blind angle around the pool wall, and the cleaning effect of the cleaning robot body 1 on the pool may be improved.

The intersection area P is 0.1 times the sum of two cleaning area by the cleaning robot body 1.

Further, there is a local intersection between two cleaning area of the cleaning robot body 1, which ensured that the cleaning robot body 1 can clean up the entire pool water surface, and there will be no omitting of cleaned water surface, which improves the cleaning effect of the cleaning robot body 1 on the pool water surface.

A cleaning robot for the water surface of pools applied to the described cleaning method for the water surface of pools, wherein cleaning robot body 1 is fixed with battery 8, wherein the angle sensor 6, the sonar 2, the two rear thrusters 3, the side thruster 4 and the battery 8 are electrically connected to the controller 7.

Guide wheels 5 are rotatably mounted at a plurality of corners of the cleaning robot body 1.

Further, by setting up a plurality of guide wheels 5, it will be able to facilitate the rolling travel of the cleaning robot body 1 against the pool wall, which improving the cleaning speed of the cleaning robot body 1 to the pool wall, and avoiding damage of cleaning robot body 1 by direct friction with swimming pool wall.

The foregoing description is merely a preferred detailed implementation of the present disclosure, but the scope of protection of the present disclosure is not limited thereto. Any people skilled in the art would be able to make equivalent replacements or changes within the technical scope disclosed by the present disclosure according to the technical solutions of the present disclosure and the inventive concept thereof, and all should be covered within the scope of protection of the present disclosure.

### REFERENCE SIGNS LIST

1 Cleaning robot body
2 Sonar
3 Rear thruster
4 Side thruster
5 Guide wheel
6 Angle sensor
7 Controller
8 Battery

What is claimed is:

1. A cleaning method of water surface of swimming pools employing a cleaning robot, the cleaning robot comprising a cleaning robot body, a sonar located around the cleaning robot body; rear thrusters located at a tail of the cleaning robot body; an angle sensor located in the cleaning robot body; a controller, and a side thruster located on a side of the cleaning robot body, the cleaning method comprising:
S1, placing the cleaning robot body into the pool in any direction,
S2, the cleaning robot body calculating an angle between a travel direction and a pool wall of the pool;
S3, when the cleaning robot body is in contact with the pool wall, and the cleaning robot moving close to the pool wall, steering in advance after a head of the cleaning robot body being at a certain distance from the pool wall, and moving close to the pool wall again;
S4, the cleaning robot body is moved to a first contact position with the pool wall, and then the cleaning robot body is moved forward in a direction perpendicular to a pool wall in front of thereof; and
S5, when the cleaning robot body is a certain distance from the front pool wall, it turns around in advance and moves forward in the opposite direction of the previous travel direction.

2. The cleaning method according to claim 1, wherein the calculation in S2 satisfied a following formula:
∠α=arcsin (X2/X1), wherein
the sonar on a head emits multiple ultrasonic beams after falling into the water, wherein the ultrasonic beams perpendicular to the cleaning robot body is X1, when the X1 is not the shortest of all the ultrasonic beams, the ultrasonic beams perpendicular to the pool wall is X2, the length of the X2 is the shortest, an angle between a side of the X1 near the X2 and the pool wall is a.

3. The cleaning method according to claim 2, wherein step S3 comprising:
if the X1 and the pool wall are tilted, turn a side of the cleaning robot body away from the side thruster through the revolving speed difference between the two rear thrusters, the cleaning robot body is steered toward the side away from the side thruster (4), through the rotation of the cleaning robot body controlled by the angle sensor in cooperation with the controller, the rotational amplitude and ∠α degrees are equal,
when the side thruster is closed to the pool wall, the steering angle of the cleaning robot body (1) is ∠α+90°;
when X1 is perpendicular to the pool wall, the cleaning robot body turns vertically toward a side away from the side thruster, and
when the side of the cleaning robot body away from the side thruster is parallel to the pool wall, start the side thruster, the side thruster pushes the cleaning robot body into contact with the pool wall, then after the two rear thrusters at the same speed push the cleaning robot body at a constant speed along the pool wall,
when cleaning robot body encounters the pool wall in the forward direction, and the cleaning robot body is X3 away from the pool wall in front of thereof, the cleaning robot body is controlled to steer vertically toward the side of X2 near the side thruster by the angle sensor in cooperation with the controller previously.

4. The cleaning method according to claim 2, wherein steps S4 and S5 comprising:
cleaning robot body is moved to the first contact position with the pool wall, and then the cleaning robot body is moved along the vertical direction with the pool wall in front of thereof, when the cleaning robot body is X4 away from the pool wall in front of thereof, the cleaning robot body is controlled to turn around toward the side of sweeping area near the pool wall by the angle sensor in cooperation with the controller, and
then cleaning robot body is previously moved in the opposite direction of the direction before turning around, the next time encountering the pool wall, the cleaning robot body is controlled to previously turn around toward the opposite direction by the angle sensor in cooperation with the controller, there is a local intersection between two travel routes of cleaning robot body, wherein an intersection area is P, and then repeat the steps of S4-S5, the water surface of the entire pool could be cleaned up.

5. The cleaning method according to claim 3, wherein the X3 is equal to turning radius of cleaning robot body.

6. The cleaning method according to claim 4, wherein the X4 is equal to turning radius of cleaning robot body.

7. Cleaning method according to claim 4, wherein the intersection area P is 0.1 times the sum of two cleaning area by the cleaning robot body.

8. A cleaning robot for the water surface of pools, which applied to the cleaning method for the water surface of pools of claim 1, wherein cleaning robot body is fixed with a battery, wherein the angle sensor, the sonar, the two rear thrusters, the side thruster and the battery are electrically connected to the controller.

9. The cleaning robot according to claim 8, wherein guide wheels are rotatably mounted at a plurality of corners of the cleaning robot body.
